(19) United States
(12) Patent Application Publication
(10) Pub. No.: US 2009/0102390 A1
(43) Pub. Date: Apr. 23, 2009

(54) CIRCUIT ARRANGEMENT FOR OPERATING A HIGH PRESSURE DISCHARGE LAMP

(75) Inventor: Bernhard Siessegger, Munchen (DE)

Correspondence Address: YOUNG & THOMPSON, 209 Madison Street, Suite 500, ALEXANDRIA, VA, 22314, US

(73) Assignee: Patent-Treuhand-Gesellschaft Fur Elektrische Gluhlampen MBH, Munchen (DE)

(21) Appl. No.: 11/666,287

(22) PCT Filed: Nov. 11, 2005
(86) PCT No.: PCT/DE2005/002031

§ 371 Date: Sep. 26, 2008

(30) Foreign Application Priority Data
Nov. 19, 2004 (DE) 10 2004 055 976.7

(51) Int. Cl. H05B 37/00

(52) U.S. Cl. 315/177

(57) ABSTRACT

A circuit arrangement for operating a high pressure discharge lamp includes a voltage transformer, a load circuit which is supplied by the voltage transformer and provided with connections for the high pressure discharge lamp (La), a choke (L2b) for limiting a current passing through the high pressure discharge lamp (La) and with an impulse igniting device for igniting a gas discharge therein, wherein the choke (L2b) is embodied in the form of the secondary winding of the igniting transformer (T2) of the impulse igniting device.

The invention relates to a circuit arrangement in accordance with the preamble of patent claim 1.

### I. PRIOR ART

Such a circuit arrangement is disclosed, for example, in EP-A 0 868 833. This document describes a circuit arrangement for operating a high pressure discharge lamp having a voltage transformer, designed as an inverter, a load circuit that is fed by the inverter and is provided with connections for a high pressure discharge lamp and with an inductor for limiting the lamp current, and a pulse ignition device for igniting the gas discharge in the high pressure discharge lamp. The circuit arrangement further has a transformer for the galvanic isolation of the inverter from the load circuit and the pulse ignition device.

### II. SUMMARY OF THE INVENTION

It is an object of the invention to provide a simplified circuit arrangement for operating a high pressure discharge lamp.

This object is achieved according to the invention by means of the features of patent claim 1. Particularly advantageous designs of the invention are described in the dependent patent claims.

The circuit arrangement according to the invention for operating a high pressure discharge lamp has a voltage transformer, a load circuit fed by the voltage transformer and which is provided with connections for a high pressure discharge lamp and with an inductor for limiting the current through the high pressure discharge lamp, and having a pulse ignition device for igniting the gas discharge in the high pressure discharge lamp, in which the inductor is designed as secondary winding of the ignition transformer of the pulse ignition device. This simplifies the structure of the circuit arrangement by comparison with the prior art, since the inductor takes over two functions, and there is no need for a semiconductor switch to deactivate the pulse ignition device. Moreover, the circuit arrangement according to the invention is suitable for operating high pressure discharge lamps that have no separate auxiliary ignition electrode.

In accordance with the preferred exemplary embodiment of the invention, a transformer is provided for adapting the input voltage of the voltage transformer to the voltage required in the load circuit, and for the galvanic isolation between voltage transformer and load circuit. The transformer preferably has two secondary windings, a first secondary winding serving to supply power to the load circuit, and the second secondary winding, if appropriate together with the first secondary winding, serving to supply power to the pulse ignition device, in order additionally also to enable a galvanic isolation between the voltage transformer and the pulse ignition device. The abovenamed transformer serves not only for the galvanic isolation, but also further permits the output voltage of the voltage transformer to be transformed to a higher value. Alternatively, instead of the abovenamed transformer, it is also possible to use an autotransformer when there is no need for a galvanic isolation between the voltage transformer and the load circuit or pulse ignition device.

In order to prevent a voltage overload of the secondary winding, arranged in the load circuit, of the transformer, a voltage-limiting, bidirectional component, for example a bidirectional Transil diode, which is also denoted as a suppressor diode or TVS diode, is advantageously connected in parallel with this secondary winding.

The load circuit advantageously has at least one capacitor that is connected in series with the inductor and whose capacitance is dimensioned in such a way that it effects a partial compensation of the inductance of the inductor during operation of the lamp, after termination of the ignition phase of the high pressure discharge lamp, in order to reduce the power loss in the circuit. If it is possible to ensure a relatively small secondary inductance of the pulse transformer, a partial compensation can then be eliminated. In any case, there should be a certain size of the secondary inductance of the pulse transformer for the purpose of stabilizing the discharge if the stabilization is not accomplished by the transformer for the purpose of adapting the input voltage of the voltage transformer to that in the load circuit, which to this end would have to exhibit a correspondingly large secondary leakage inductance. It is likewise possible to stabilize the discharge with the inclusion of two components.

The voltage transformer is advantageously designed as a single-transistor transformer for the purpose of further simplification of the circuit arrangement. This is to be understood in the sense of a single transistor switched at high frequency. The circuit is distinguished by very low switching losses, since owing to the selection of the switching frequency and of the pulse duty factor the switching transistor is driven in such a way that it is switched on and off only in the de-energized state (zero-voltage switching, ZVS).

The voltage transformer of the circuit arrangement according to the invention preferably comprises at least one switching means that switches at periodically recurring time intervals, and means for changing the switching frequency of the at least one switching means after ignition of the gas discharge has been performed in the high pressure discharge lamp, in order in a simple way to enable the power of the high pressure discharge lamp to be regulated after ignition of the gas discharge has been performed. In particular, the means for changing the switching frequency of the at least one switching means are preferably designed in such a way that immediately after ignition of the gas discharge has been performed in the high pressure discharge lamp there is a sudden change in the switching frequency of the at least one switching means, and there is a continuous or quasi-continuous change in the switching frequency subsequently, during the run-up or start-up phase of the high pressure discharge lamp. Owing to the sudden change in the switching frequency, the ignition device is deactivated, and regulation of the power of the high pressure discharge lamp is enabled by virtue of the continuous or, in the case of a digital control device, quasi-continuous change in the switching frequency of the at least one switching means of the voltage transformer. As the high pressure discharge lamp is being run up or started up, that is to say while the constituents of the discharge medium are vaporizing, the switching frequency can therefore be set such that the high pressure discharge lamp is operated at a power revised above the nominal power, in order to shorten the duration of the start-up phase. Subsequently, the switching frequency can be varied continuously or quasi-continuously until a final value of the switching frequency is reached in stationary operation of the high pressure discharge lamp, in order to operate the high pressure discharge lamp with a power that corresponds substantially to its nominal power.

### III. DESCRIPTION OF THE PREFERRED EXEMPLARY EMBODIMENT

The invention is explained in more detail below with the aid of a preferred exemplary embodiment. In the drawing:

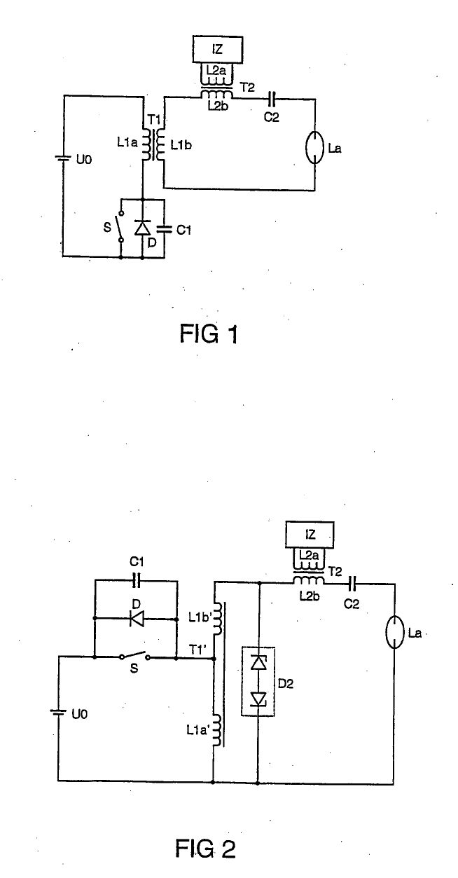

FIG. 1 shows a sketched circuit diagram of the circuit arrangement in accordance with the first exemplary embodiment,

FIG. 2 shows a sketched circuit diagram of the circuit arrangement in accordance with the second exemplary embodiment,

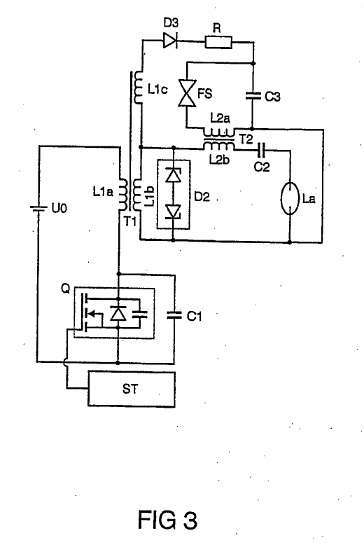

FIG. 3 shows a detailed sketched circuit diagram of the circuit arrangement in accordance with the first exemplary embodiment,

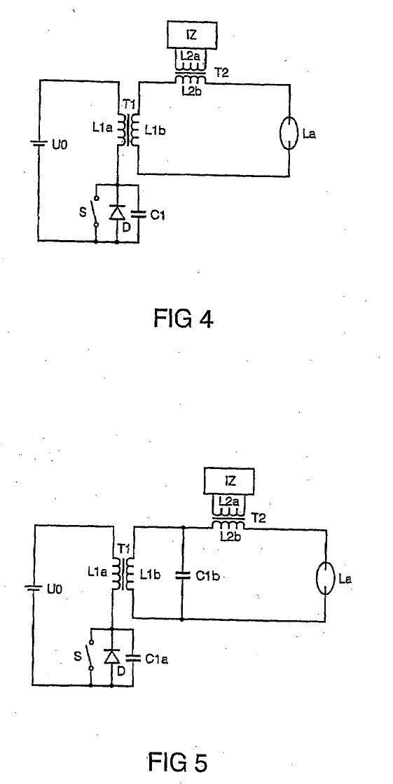

FIG. 4 shows a sketched circuit diagram of the circuit arrangement in accordance with the third exemplary embodiment, FIG. 5 shows a sketched circuit diagram of the circuit arrangement in accordance with the fourth exemplary embodiment, and

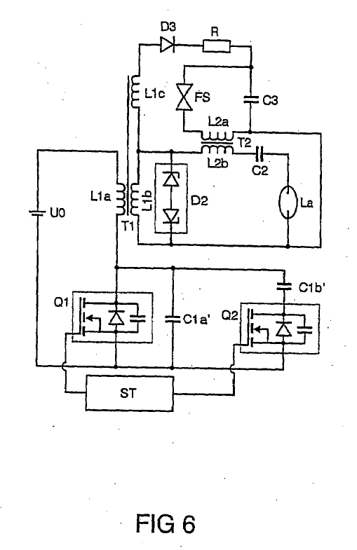

FIG. 6 shows a sketched circuit diagram of the circuit arrangement in accordance with the fifth exemplary embodiment.

FIG. 1 is a schematic of the first exemplary embodiment of the circuit arrangement according to the invention. This circuit arrangement includes a single-transistor voltage transformer that is connected to a DC voltage source U0, and is formed by the primary winding L1a of a transformer T1 and a semiconductor switch S with a diode D, connected back-to-back in parallel, and a capacitor C1 connected in parallel with the switch S, and a load circuit that is coupled to the voltage transformer via the transformer T1, as well as a pulse ignition device IZ, T2 for igniting the gas discharge in the high pressure discharge lamp La. Arranged in the load circuit are the secondary winding L1b of the transformer T1, the inductor L2b, the capacitor C2 and the high pressure discharge lamp La or connections for the high pressure discharge lamp La. The inductor L2b is, moreover, designed as secondary winding of the ignition transformer T2 of the pulse ignition source.

The second exemplary embodiment of the invention, depicted in FIG. 2, differs from the first exemplary embodiment only in that an autotransformer T1′ is used instead of the transformer T1. For this reason, identical reference symbols are used for identical components in FIGS. 1 and 2. The load circuit and the voltage input of the pulse ignition device IZ, T2 are fed by the primary winding section L1a′ and the second winding section L1b′ of the autotransformer T1′.

FIG. 3 illustrates details of the first exemplary embodiment, and details of the pulse ignition device IZ, T2, depicted as a block diagram in FIGS. 1 and 2, and of the semiconductor switch S or Q. The semiconductor switch S is illustrated in FIG. 3 as field effect transistor Q with an integrated body diode and parasitic capacitance. Energy is supplied to the pulse ignition device IZ, T2 with the aid of the two secondary windings L1b, L1c of the transformer T1 by the single-transistor voltage transformer. During the ignition phase of the high pressure discharge lamp La, the ignition capacitor C3 is charged up to the breakdown voltage of the spark gap FS via is the rectifier diode D3 and the resistor R. Once the abovementioned breakdown voltage has been reached, the ignition capacitor C3 discharges via the spark gap FS and the primary winding L2a of the ignition trans-former T2. This generates in the secondary winding L2b of the ignition transformer T2 high voltage pulses that lead to ignition of the gas discharge in the high pressure discharge lamp La. A bidirectional suppressor diode D2 is connected in parallel with the first secondary winding L1b or to the winding sections L1a′, L1b′ in order to avoid a voltage overload of the first secondary winding Lib, connected into the load circuit, of the transformer T1 or the winding sections L1a′, L1b′ of the autotransformer T1′. The field effect transistor Q of the voltage transformer is operated at a switching frequency of approximately 220 kHz by means of its drive device ST in order to ignite the gas discharge in the high pressure discharge lamp La. It is thereby possible to build up the requisite breakdown voltage of the spark gap FS at the ignition capacitor C3 on the basis of the dimensioning of the components that is specified in the table. Upon termination of the ignition phase, the switching frequency of the transistor Q is switched over to the value of 750 kHz, and subsequently raised up to 820 kHz in a fashion corresponding to the vaporization of the filling constituents of the discharge vessel of the lamp La. As the lamp is running up, it is fed a power substantially greater than the nominal power, in order to ensure a rapid run-up, that is to say a rapid vaporization of the filling constituents. In stationary operation, the switching frequency is selected in such a way that the high pressure discharge lamp La is operated at its nominal power of 35 watts. On the basis of the then conductive discharge path of the high pressure discharge lamp La, no further high voltage pulses are generated by the pulse ignition device after termination of the ignition phase. After termination of the ignition phase, the secondary winding L2b, which is arranged in the load circuit and through which lamp current flows, of the ignition transformer T2 serves as inductor limiting the lamp current, that is to say to stabilize the discharge. The capacitance of the capacitor C2 connected in series with the secondary winding or inductor L2b is dimensioned in such a way that it partially compensates the inductance of the inductor L2b, in order to limit the voltage drop across the inductor L2b to the dimension required for stabilizing the discharge, and therefore to reduce the power loss in the circuit.

FIG. 4 is a schematic of a circuit arrangement in accordance with the third exemplary embodiment of the invention. This exemplary embodiment differs from the first exemplary embodiment only in that the circuit arrangement in accordance with the third exemplary embodiment has dispensed with the capacitor C2 and the secondary winding L2b of the ignition transformer has 20 turns and an inductance of 32 μH. In all other details, the third exemplary embodiment corresponds to the first exemplary embodiment depicted in FIGS. 1 and 3. Consequently, the same reference symbols have also been used for identical parts.

FIG. 5 is a schematic of a circuit arrangement in accordance with the fourth exemplary embodiment of the invention. This exemplary embodiment differs from the third exemplary embodiment only in that the capacitor C1 has been replaced by the two capacitors C1a and C1b, the capacitor C1a being connected in parallel with the switching path of the switching transistor S and of its body diode D, and the capacitor C1b being connected in parallel with the secondary winding L1b of the transformer T1. The bidirectional suppressor diode D2 is eliminated in this exemplary embodiment, because in addition to its own function, the capacitor C1b additionally acts in concert with C1a as a voltage-limiting component, and ensures that the voltage generated by the ignition transformer is applied to the lamp. The following condition is fulfilled for the capacitances of the capacitors C1a, C1b and C1:

$$k 1 a + k 1 b \cdot {( \frac{n 1 b}{n 1 a} )}^{2} = k 1 ,$$

k1, k1a, k1b denoting the capacitances of the capacitors C1, C1a, C1b and n1a, n1b denoting the number of turns per unit length of the primary winding L1a or secondary winding L1b of the transformer T1.

The capacitor C1 or C1a can also be connected in parallel with the primary winding L1a of the transformer T1 instead of in parallel with the switching transistor S.

The value of the capacitance C1 can be varied in order to adapt to different load conditions or to ensure the switching function in the case of a restricted frequency range. This is advantageously performed in stages, MOSFET transistors being used as switches. MOSFET transistors enable a bidirectional flow of current in the switched-on state, and the body diode present in the switched-off state is not an obstacle in this application, since no negative voltage across C1 can occur, given the diode D present in the circuit, and so the switches used for varying C1 need not exhibit any reverse blocking ability. FIG. 6 shows one design. In this case, for example, C1a′ and C1b′ can be dimensioned such that, as described in the case of the first exemplary embodiment, after the lamp has been ignited instead of there being a changeover in frequency the MOSFET Q2 is driven by means of the control circuit ST in order to activate or deactivate the capacitor C1b′ and, by contrast with the above designs, there is no switchover of the switching frequency. For example, Q2 can be driven directly by an output of a microcontroller, without the need for a correspondingly quick gate drive circuit as in the case of Q1. In the extreme case, C1a′ can be eliminated completely, and its function can be taken on exclusively by the parasitic capacitance of the MOSFET Q1. Like the selection of C1, switching over or varying C1 should in this case be done such that the switch S or Q always switches in the de-energized state of the switch (zero-voltage switching, ZVS), “always” meaning both during the ignition and in the subsequent operation.

The circuit arrangement in accordance with the fifth exemplary embodiment of the invention, which is illustrated schematically in FIG. 6, differs from the first exemplary embodiment only in that the capacitor C1 is replaced by the two capacitors C1a′ and C1b′, the capacitor C1a′ being connected in parallel with the switching path of the switching transistor Q1 and of its body diode, and the series circuit consisting of the capacitor C1b′ and a second switching transistor Q2 being connected in parallel with the capacitor C1a′. Consequently, identical reference symbols were used for identical components in FIGS. 3 and 6.

The high pressure discharge lamp La is a mercury-free halogen metal vapor high pressure gas discharge lamp with a nominal power of 35 W in stationary operation, and a nominal lamp voltage of 45 V, for use in a motor vehicle headlight. Apart from a small air gap, the ignition transformer L2a, L2b has a magnetic circuit closed in a soft magnetic material (for example ferrite).

TABLE
Dimensioning of the components of the circuit arrangement, depicted in
FIGS. 1 and 3, in accordance with the first exemplary embodiment

| | |
|---|---|
| C1 | 3.7 nF |
| C2 | 1.3 nF |
| C3 | 10 nF, 2000 V |
| D2 | Two P6KE520C in series |
| D3 | BY505 |
| FS | 1600 V |
| Q | IRF740LC |
| R | 20 kOhm |
| T1 | EFD25, N49 with air gap |
| L1a | 13 turns, 16 μH |
| L1b | 46 turns |
| L1c | 46 turns |
| L2a | 1 turn |
| L2b | 19 turns, 63 μH, annular core |
| | with air gap (1 mm) |
| U0 | 42 V |

1. A circuit arrangement for operating a high pressure discharge lamp, the circuit arrangement having a voltage transformer, a load circuit fed by the voltage transformer and which is provided with connections for the high pressure discharge lamp (La) and with an inductor (L2b) for limiting the current through the high pressure discharge lamp (La), and having a pulse ignition device for igniting the gas discharge in the high pressure discharge lamp (La), characterized in that the inductor (L2b) is designed as secondary winding of the ignition transformer (T2) of the pulse ignition device.

2. The circuit arrangement as claimed in claim 1, characterized in that a transformer (T1) is provided for adapting the input voltage (U0) to the voltage required in the load circuit, and for the galvanic isolation between voltage transformer and load circuit.

3. The circuit arrangement as claimed in claim 2, characterized in that the transformer (T1) has two secondary windings (L1b, L1c), a first secondary winding (L1b) serving to supply power to the load circuit, and the second secondary winding (L1c), if appropriate together with the first secondary winding (L1b), serving to supply power to the pulse ignition device.

4. The circuit arrangement as claimed in claim 2, characterized in that a voltage-limiting component (D2) is connected in parallel with the secondary winding (L1b), arranged in the load circuit, of the transformer (T1).

5. The circuit arrangement as claimed in claim 1, characterized in that connected in series with the inductor (L2b) is at least one capacitor (C2) whose capacitance is dimensioned in such a way that the at least one capacitor (C2) effects a partial compensation of the inductance of the inductor (L2b) during operation of the lamp, after termination of the ignition phase.

6. The circuit arrangement as claimed in claim 1, characterized in that the voltage transformer is designed as a single-transistor transformer.

7. The circuit arrangement as claimed in claim 1, characterized in that a transformer (T1′) designed as an autotransformer is provided for adapting the input voltage (U0) to the voltage required in the load circuit.

8. The circuit arrangement as claimed in claim 7, characterized in that the primary (L1a′) and the secondary winding section (L1b′) of the autotransformer (T1′) serve to supply power to the load circuit and the pulse ignition device.

9. The circuit arrangement as claimed in claim 8, characterized in that a voltage-limiting component (D2) is connected in parallel with the series circuit of the winding sections (L1a′, L1b′) of the autotransformer (T1′).

10. The circuit arrangement as claimed in claim 1, in which the voltage transformer comprises at least one switching means (S, Q, Q1) that switches at periodically recurring time intervals, and in which means (ST) are provided for changing the switching frequency of the at least one switching means (S, Q, Q1) after ignition of the gas discharge has been performed in the high pressure discharge lamp (La).

11. The circuit arrangement as claimed in claim 10, characterized in that the means (ST) for changing the switching frequency of the at least one switching means (S, Q, Q1) are designed in such a way that immediately after ignition of the gas discharge has been performed in the high pressure discharge lamp there is a sudden change in the switching frequency of the at least one switching means (S, Q, Q1), and there is a continuous or quasi-continuous change in the switching frequency subsequently, during the run-up or start-up phase of the high pressure discharge lamp.

12. The circuit arrangement as claimed in claim 3, characterized in that a voltage-limiting component (D2) is connected in parallel with the secondary winding (L1b), arranged in the load circuit, of the transformer (T1).
